(19) United States
(12) Patent Application Publication
(10) Pub. No.: US 2009/0064100 A1
(43) Pub. Date: Mar. 5, 2009

(54) SYSTEM, METHOD, AND COMPUTER PROGRAM PRODUCT FOR RECORDING OPERATIONS PERFORMED ON COMPUTER SOURCE CODE

(76) Inventor: Jan Schiefer, Seattle, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/848,890

(22) Filed: Aug. 31, 2007

(51) Int. Cl. G06F 9/45

(52) U.S. Cl. 717/110

(57) ABSTRACT

A system, method, and computer program product are described. An example system comprises a development module creating and editing a plurality of classes in a plurality of files, the development module performing an operation that changes one of the classes and makes references to the class consistent with the change throughout the plurality of files, and a management module in communication with the development module storing the plurality of files, the management module creating and storing a record of the operation.

### TECHNICAL FIELD

The present description relates, in general, to code-development systems and, more specifically, to the storage of information regarding operations on files.

### BACKGROUND OF THE INVENTION

Object-Oriented Programming (OOP) has been a technology adopted widely in the computing industry. Program functionality is decomposed into classes, which encapsulate parts of the behaviors of the program. Instances of these classes (often called) objects communicate by calling each other's methods to invoke actions. Designing external and internal interfaces to these objects are key design tasks for program architects.

Program source code is typically recorded in a Software Configuration Management system (SCM). The source code is stored in files, where one file contains one or more class definitions. Revisions of individual files are typically stored either as complete text, or as the difference (i.e., delta) with respect to the previous version.

Sometimes it may be desirable to change an external interface of a class to make code more readable or maintainable. However, changing external interfaces of classes can have ripple-on effects throughout the whole software system. For example, if in a class A the name of method foo( ) is changed to bar( ), in all classes throughout the whole system, references to A::foo( ) should be changed to A::bar( ).

The term commonly used for modifying computer code (usually without changing the program's external behavior) is “refactoring”. The process of changing references throughout a system, as described above, is one kind of refactoring. Recently, refactoring has become an operation that is supported by Integrated Development Environments (IDEs) for various programming languages. An example of such an IDE is the Eclipse Framework, available from the Eclipse Foundation.

Even in IDEs that can support refactoring operations, a problem lies in the interaction between the refactoring operation and the SCMs (or rather the lack of communication). A single refactoring operation can create changes in a multitude of classes and the files that store the classes. As typical SCM systems store versions of files only, the relationships between, and reasons for, the various changes made (e.g., the fact that a number of changes were created by the same refactoring operation) get lost. This is especially problematic when “merging” changes from one version of a file to the next, as a large number of changes may be attributable to refactoring, yet this knowledge is not retained in the SCM system.

### BRIEF SUMMARY OF THE INVENTION

Various embodiments of the invention are directed to systems, methods, and computer program products that are operable to store information with regard to events (e.g., refactoring) affecting the files in an SCM. In one example, the SCM is configured to record operations that modify files, such as refactoring operations, each as separate events. If the event has a ripple-on effect on other files and versions, the event is linked to files and file versions affected by the operation, such that the knowledge of what caused changes in many related files is preserved. In this example, the SCM records meta-information about the cause of the transformation of one or more source files. The meta-information can be applied, for example, when merging file revisions.

For instance, one specific example method records changes to classes and references to those classes. The example method includes performing an operation upon a plurality of files, thereby changing a class and references to the class. Then, a record is created of the occurrence of the operation. In some examples, the record includes information indicating the type of operation, the change that was performed during the operation, and file versions that are affected by the operation. Subsequent to the creation of the record, upon occurrence of an event (e.g., a second operation), the record is consulted to determine, for example, possible inconsistencies resulting from the first and/or second operation. Further, in this example, a user is presented an option to perform an operation on one or more files to create consistencies among files and/or versions.

Various embodiments of the invention facilitate a developer's management of complex code that uses a multitude of files. With respect to prior art systems, there was often a belief that SCM capability should be limited to text processing and file storing, whereas code parsing should reside only in IDEs. Various embodiments of the invention defy this tradition by including code-parsing capabilities in SCMs and adapting such SCMs to record changes to files. Various embodiments may provide one or more advantages over prior art systems.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system, adapted according to one embodiment of the invention;

FIG. 2 is an illustration of an exemplary entry in a file of an SCM according to one embodiment of the invention

FIG. 3 is an illustration of an exemplary dialog adapted according to one embodiment of the invention;

FIG. 4 is an illustration of an exemplary method adapted according to one embodiment of the invention; and

FIG. 5 illustrates an example computer system adapted according to one embodiment of the present invention.

### DETAILED DESCRIPTION OF THE INVENTION

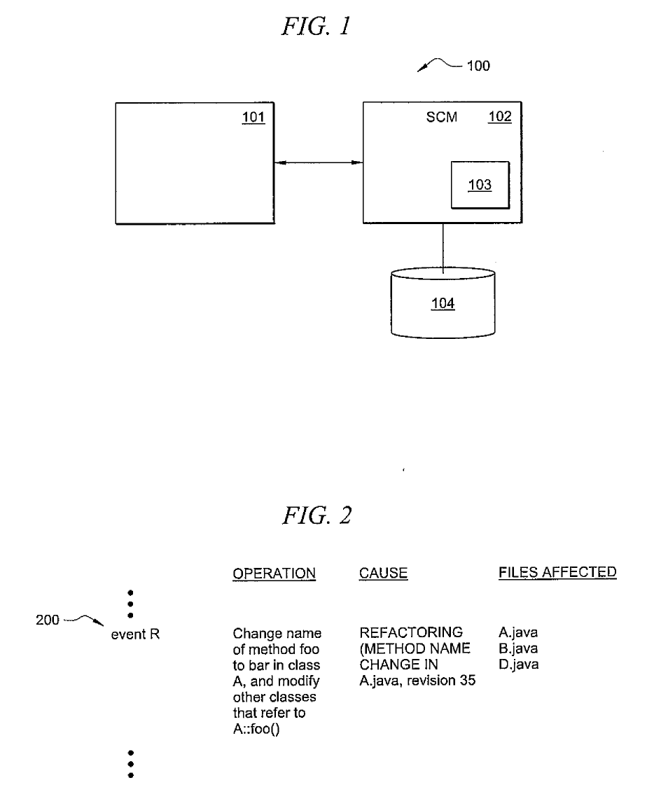

FIG. 1 is an illustration of exemplary system 100, adapted according to one embodiment of the invention. System 100 includes code writing/development module 101. In some embodiments, module 101 is an IDE that has a user interface to receive programmer input and display information to the programmer. A programmer can use module 101 to write and edit computer-executable code, including performing refactoring and other operations.

Module 101 is in communication with SCM system 102, which stores versions of files. In typical operation, the code developed and edited by a programmer using module 101 will be stored in database 104 of SCM 102 in various files. SCM 102 further includes event recording module 103, which is operable to save meta-information about events that affect the files in SCM 102. Through use of system 101, a programmer can take advantage of the meta-information, especially during merging and other tasks that require managing the complexity of the code. SCM 102 can be used to manage files and file versions that are changed by a variety of operations, including refactoring operations. Refactoring operations that can be accommodated by various embodiments of the invention include, for example:

replacing “if” conditionals with polymorphisms,

field encapsulation,

method extraction (creating two or more methods out of one large method),

type generalization,

pull-ups and push-downs, and

method renaming.

In FIG. 1, modules 101 and 102 are shown separately for convenience of illustration. In some embodiments, modules 101 and 102 are separate computer programs that interact with each other and may be run on the same processor or on different processors. In fact, modules 101 and 102 can be on different computers connected by a network, such as Local Area Network (LAN), the Internet, or other network over wires or over the air. In other embodiments, modules 101 and 102 are parts of the same computer program, such as a product suite that includes an IDE and an SCM.

The following example is provided to illustrate a possible scenario wherein system 100 is used to perform a refactoring operation and then to merge another file, while keeping the external interface of a class consistent.

Class A is defined in the source file A java, the current revision is 34.

Class B is defined in the source file B java, the current revision is 11.

Class C is defined in the source file C java, the current revision is 19.

Class D is defined in the source file D java, the current revision is 42.

Further in this example, classes B and D contain references to class A. Programmer one decides to change the name of method foo( ) in class A to bar( ). She invokes a refactoring operation through module 101. Module 101 discerns through dependency analysis that the method name change has an impact on classes B and D also. Hence, module 101 triggers module 102 to record the change. Module 102 stores a representation of the refactoring operation R (e.g., “in class A, change foo( ) to bar( ) and also modify all other classes that refer to A::foo( )”). Module 102 also creates a new revision 35 of class A, 12 of class B, and 43 of class D. Module 102 then links the new and old revisions to the operation R to record the reason for the change.

FIG. 2 is an illustration of exemplary entry 201 in a file of an SCM (e.g., module 102) according to one embodiment of the invention. Entry 201 is an example of a database entry that is created in response to programmer one's method name change described above. In addition to including information that indicates that the change has been made, entry 200 also includes information indicating the nature of cause of the change (in this example, method name change refactoring). Entries above and below entry 200 are replaced with ellipses to illustrate that a given database entry may be one of many entries in the database, especially if the program being developed is quite complex. The manner of storing entry 201 can differ among various embodiments. For example, it can be one of many entries in a file that is stored in a database (e.g., database 104) along with the source files to which it refers. Additionally or alternatively, entry 201 may be in a file that is stored separately from the source files. Further, various embodiments may store data related to an operation in its own file separate from data related to other operations. It should also be noted that various embodiments of the invention may add, omit, or rearrange the types of information that are shown in entry 201 when storing meta-information regarding operations on files.

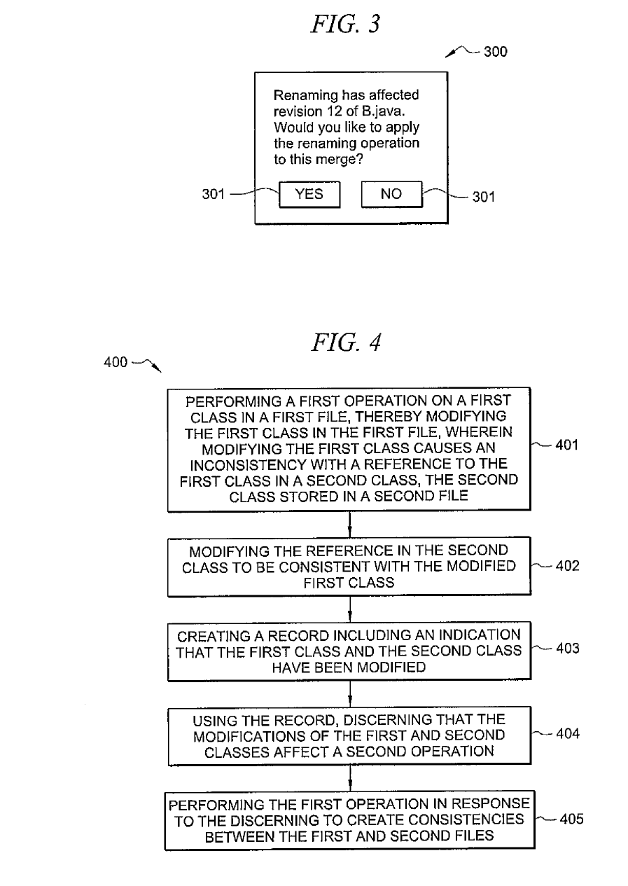

Later, programmer one's colleague, programmer two, decides to incorporate some of programmer one's changes. Programmer two has been using revision 8 of file B.java and would like to catch up to the latest revision 12. As he merges the file B.java, module 102 alerts him that one of the changes in revision 12 was caused by a refactoring operation. Module 102 inquires whether programmer two wants to apply the refactoring operation as part of the merge. FIG. 3 is an illustration of exemplary dialog 300 adapted according to one embodiment of the invention. Dialog 300, in this example, is displayed to programmer two in response to the merging operation, and it includes buttons 301 and 302 to receive input from programmer two.

In this example, programmer two desires to keep an older version of class D around, while still keeping references to interfaces consistent across the files. Accordingly, programmer two indicates to module 102 (through an interface in module 102 or through an interface in module 101) that he selects a “yes” option, thereby instructing module 102 to apply the renaming operation to his files. In response, module 102 applies the renaming operation to classes A, B and D. Despite the fact that programmer two does not want to use the latest version of class D, after applying the renaming operation, he has a consistent set of interfaces and references for all classes.

In prior art systems, the merge would not have been as simple or as intuitive as in the example above. In a prior art system, programmer two would have merged file B.java only and found an undefined reference to a function A::bar( ) that does not exist. He then would have had to 1) search the versions of A.java to discover when the method name change was introduced, 2) merge that version of A.java, 3) and find an undefined reference in D.java, which refers to A::foo( ), which no longer exists. As programmer two does not want the latest version of D, he would have to manually change the invocation of A::foo( ) to A::bar( ).

FIG. 4 is an illustration of exemplary method 400 adapted according to one embodiment of the invention. Method 400 is performed, in some embodiments, by a processor-based device (e.g. a personal computer, a multi-processor server-type computer, and the like) running one or more modules the same as or similar to modules 101 and 102 of FIG. 1. Interaction between the processor-based device and a user in many examples in through a Graphical User Interface (GUI), although it is possible that some embodiments may use other kinds of interfaces, such as text-based interfaces and interfaces for the visually impaired.

In step 401, a first operation is performed on a first class in a first file, thereby modifying the first class in the first file. An example of such an operation is a refactoring operation that changes a name of a method in the class. Modifying the first class causes an inconsistency in a reference to the first class in a second class, and the second class is stored in a second file. For example, when the second class refers to the first method, the change of the name of the method in the first class causes the method name and the reference to be mismatched.

In step 402, the reference in the second class is modified to be consistent with the modified first class. For example, the reference in the second class is changed to reflect the name change of the method.

In step 403, a record is created, the record including an indication that the first class and the second class have been modified. An example of such a record in shown in FIG. 2. The record may further include an indication of file versions that are affected by the first operation.

In step 404, using the record, it is discerned that the modifications of the first and second classes affect a second operation. An example of a second operation that is affected by previous operations on classes is a merge operation that merges a version of a file that includes a change to the first or second class. In some example embodiments, records of various operations are consulted during operation of an IDE to determine if a given operation is affected by previous operations. Step 404 may also include notifying a programmer that a requested operation is affected by one or more previous class change operations and giving the programmer a prompt to select in order to apply the first operation (in whole or in part) to make the resulting class versions consistent throughout.

In step 405, the first operation is performed in response to the discerning to create consistencies between the first and second files. For example, when the second operation causes a file version to be updated so that it includes a change to a method or a reference, the first operation can be performed on one or more files to make the method and references consistent throughout.

While method 400 is shown as a series of discrete steps, it should be noted that it is within the scope of embodiments to add, delete, modify, and/or rearrange various steps. For example, the steps of method 400 my repeated one or more times, even during a single sitting, by a programmer during development. Method 400 illustrates a scenario wherein an embodiment of the invention records a renaming operation and creates consistency among files after a merge operation. It should be noted, though, that renaming is only one of the various operations that can be recorded by an embodiment of the invention, as other operations, including refactoring operations, can be accommodated by some embodiments. For instance, in another example embodiment, an SCM creates meta-information that indicates that a method extraction operation has created three methods out of one method. The SCM uses its code parsing ability to discern that the change has occurred, and it records the meta-information in a file. Later, when another operation is performed, such as a merging operation, the SCM determines that various merged files are affected by the extraction method and performs the extraction in the other files. Further, various embodiments of the invention may be adapted for use in non-object-oriented-systems, for example, by configuring a system to parse such code and discern when changes are made to the code.

When maintaining a large code base through an SCM system, it is often hard to remember (or second-guess) what caused a particular change, or set of changes when using prior art systems. Such issue can be particularly acute if a change applies to multiple source files, as is often the case in refactoring. Various embodiments of the invention can often simplify management of complex source code by storing an indication of a code change, rather than just the outcome of the change.

For example, when merging a file, the file change operation can be applied as part of the merge. In other words, when source file A is merged, the change (i.e., an occurrence of a refactoring operation or other operation) is applied to the source files B and D, which are also affected by the change. Such concept goes above and beyond the existing paradigm wherein SCM systems record the versions of the individual files only. In other words, various embodiments of the invention allow an SCM system to store information with respect to operations performed on files (or groups of files), in addition to storing the files themselves.

In summary, various embodiments of the invention can greatly simplify the task of managing changes in complex software systems that involve more than one file. As managing complexity is one of the major challenges of software development today, various embodiments can have a great impact on productivity.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like). In fact, readable media can include any medium that can store information.

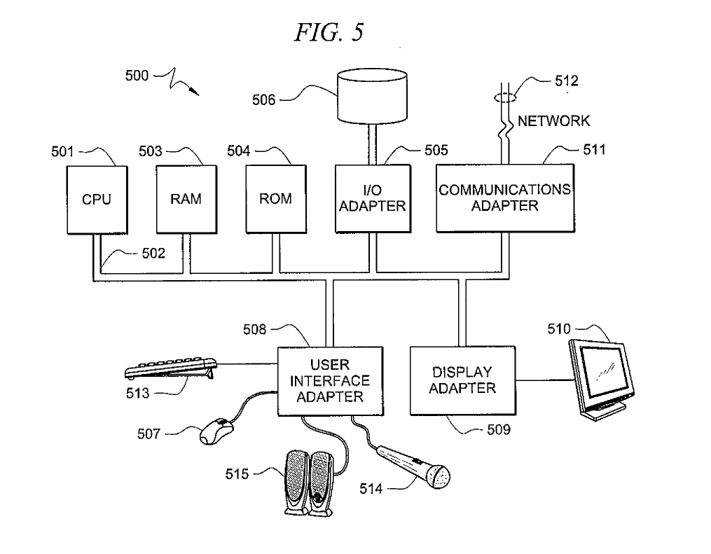

FIG. 5 illustrates an example computer system 500 adapted according to embodiments of the present invention. That is, computer system 500 comprises an example system on which embodiments of the present invention may be implemented (such as a computer that runs modules 101, 102, and 103 of the example implementation of FIG. 1). Central processing unit (CPU) 501 is coupled to system bus 502. CPU 501 may be any general purpose CPU. However, the present invention is not restricted by the architecture of CPU 501 as long as CPU 501 supports the inventive operations as described herein. CPU 501 may execute the various logical instructions according to embodiments of the present invention. For example, CPU 501 may execute machine-level instructions according to the exemplary operational flows described above in conjunction with FIG. 4.

Computer system 500 also preferably includes random access memory (RAM) 503, which may be SRAM, DRAM, SDRAM, or the like. Computer system 500 preferably includes read-only memory (ROM) 504 which may be PROM, EPROM, EEPROM, or the like. RAM 503 and ROM 504 hold user and system data and programs, as is well known in the art.

Computer system 500 also preferably includes input/output (I/O) adapter 505, communications adapter 511, user interface adapter 508, and display adapter 509. I/O adapter 505, user interface adapter 508, and/or communications adapter 511 may, in certain embodiments, enable a user to interact with computer system 500 in order to input information, such as edits to code, operations on code, drafting of new code, and the like.

I/O adapter 505 preferably connects to storage device(s) 506, such as one or more of hard drive, compact disc (CD) drive, floppy disk drive, tape drive, etc. to computer system 500. The storage devices may be utilized, for example, when RAM 503 is insufficient for the memory requirements associated with storing data. Communications adapter 511 is preferably adapted to couple computer system 500 to network 512 (e.g., the Internet, a LAN, a wireless network, and the like). User interface adapter 508 couples user input devices, such as keyboard 513, pointing device 507, and microphone 514 and/or output devices, such as speaker(s) 515 to computer system 500. Display adapter 509 is driven by CPU 501 to control the display on display device 510 to, for example, display the user interface (such as that of FIG. 3) of embodiments of the present invention.

It shall be appreciated that the present invention is not limited to the architecture of system 500. For example, any suitable processor-based device may be utilized, including without limitation personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for recording operations performed on computer code, the method comprising:
performing a first operation on code in a first file, thereby modifying said code in said first file, wherein said modifying said code in said first file causes an inconsistency with code stored in a second file;
modifying said code in said second file to be consistent with said modified code in said first file; and
creating a record including an indication that said code in said first file and said code in said second file have been modified.

2. The method of claim 1 further comprising:
storing said record in a third file, said first, said second, and said third files stored together in a database.

3. The method of claim 1 further comprising:
comparing said modifications of said code in said first and second files to a second operation;
discerning that the modifications of said code in said first and second files affect said second operation using said record; and
performing said first operation in response to said discerning to create consistencies between said first and second files.

4. The method of claim 3 wherein said first operation is a refactoring operation that changes a name of a method in a first class in said first file and a reference to said method in said second file, and wherein said second operation is a merge operation that changes a version of said second file.

5. The method of claim 1 further comprising:
displaying results of said modifying and said creating to a user via a Graphical User Interface (GUI).

6. The method of claim 1 further comprising:
receiving input from a user through a Graphical User Interface (GUI) instructing said first operation to be performed.

7. The method of claim 1 wherein said created record includes information with respect to versions of files affected by said first operation.

8. The method of claim 1 wherein said created record includes information indicating a nature of said first operation.

9. A computer program product having a computer readable medium having computer program logic recorded thereon, said computer program product comprising:
(a) code, when executed by a computer, performing a first modifying operation upon a plurality of files;
(b) code, when executed by a computer, creating a record of said first modifying operation; and
(c) code, when executed by a computer, consulting said created record when a second modifying operation is performed on one or more of said files.

10. The computer program product of claim 9 further comprising:
code, when executed by a computer, storing in said record an indication of versions of said files affected by said first modifying operation.

11. The computer program product of claim 9 wherein said first modifying operation is a refactoring operation changing a class and references to said class.

12. The computer program product of claim 11 further comprising:
code, when executed by a computer, presenting an option to perform said refactoring once more based upon said consulting.

13. The computer program product of claim 9 further comprising:
code, when executed by a computer, storing said plurality of files and said created record together in a database.

14. The computer program product of claim 9 wherein said created record includes information indicating a nature of said first operation.

15. A system comprising:
a development module creating and editing code in a plurality of files, said development module performing an operation that changes a portion of said code and makes references to said code portion consistent with said change throughout said plurality of files; and
a management module in communication with said development module storing said plurality of files, said management module creating and storing a record of said operation.

16. The system of claim 15 wherein each of said files includes a class, and said changed code portion defines a method of one of said classes.

17. The system of claim 15 wherein said management module consults said record of said operation in response to another operation, using said record to identify and correct inconsistencies created by said other operation.

18. The system of claim 15 further comprising:
a processor-based device running software to generate said modules, said processor-based device including a user interface presenting output and receiving input.

19. The system of claim 15 wherein said management module comprises:
a database storing said plurality of files and said record of said operation.

20. The system of claim 15 wherein said record includes information indicating a nature of said operation.
